(19) United States
(12) Patent Application Publication
(10) Pub. No.: US 2013/0137340 A1
(43) Pub. Date: May 30, 2013

(54) UNDERWIRE FOR A BRASSIERE

(71) Applicant: Zhenqiang Liu, Kwai Chung (HK)

(72) Inventor: Zhenqiang Liu, Kwai Chung (HK)

(21) Appl. No.: 13/390,844

(22) PCT Filed: Nov. 29, 2011
(86) PCT No.: PCT/CN2011/083177

§ 371 Date: Feb. 16, 2012

(51) Int. Cl. A41C 1/14; B29C 45/14

(52) U.S. Cl. 450/41; 264/258; 425/129.1

(57) ABSTRACT

There is provided an underwire for a brassiere. In a first embodiment, the underwire is made of two or more different materials. In a second embodiment, one end of the underwire is tapered.

A method of manufacturing the underwire and a mold for manufacturing the underwire are also provided.

### FIELD OF THE INVENTION

The present invention relates to an underwire for a brassiere. The invention also relates to an underwire assembly for a brassiere and a brassiere comprising the underwire. A method of manufacturing the underwire and a mold for manufacturing the underwire are also provided.

### BACKGROUND OF THE INVENTION

The function of an underwire in a brassiere is to provide support. A conventional underwire for a brassiere is a substantially U-shaped metallic wire having a substantially rectangular cross section, such as disclosed in U.S. Pat. No. 7,179,150. As described in U.S. Pat. No. 7,179,150, the metallic wire underwire is inserted into a fabric sock to form an underwire assembly comprising the metallic wire within the fabric sock.

For a conventional metallic underwire, typically the underwire is not fixed to the sock, but instead there is some “wire play” to allow the underwire to move a little bit within the sock. Such wire play is to avoid the sock shrinking upon washing and thereby causing the metallic wire to pierce the fabric sock, and also to avoid friction (for example during washing) causing the metallic wire to pierce the fabric sock. However, such “wire play” has the disadvantage that movement of the wire may cause the wire to be “dislocated” thereby affecting the performance of the brassiere both in terms of providing support and aesthetically.

Furthermore, comfort for a brassiere wearer remains a problem with brassieres comprising a conventional metallic underwire.

It is an aim of the present invention to provide an underwire which enables a brassiere comprising that underwire to be more comfortable for a wearer of the brassiere and which avoids the disadvantages associated with “wire play”.

### SUMMARY OF THE INVENTION

In a first aspect of the invention, there is provided an underwire for a brassiere, wherein the underwire is made of two or more different materials. By providing an underwire of two different materials, the properties of the underwire can be made to vary across the length of the underwire. One end of the underwire may be tapered. By tapering the end of the underwire, the underwire is more easily inserted into a fabric sock to produce an underwire assembly. Another advantage is that a tapered end is more easily fixed to the fabric sock by stitching means such as by bar tacking. In a preferred embodiment, both ends of the underwire are tapered.

In a second aspect of the invention, there is provided an underwire for a brassiere, wherein one end of the underwire is tapered. In a preferred embodiment, both ends of the underwire are tapered. By tapering the end(s) of the underwire, an advantage is that the end is more flexible providing increased comfort to the user.

The underwire of either aspect of the invention may be made of a metal and a plastics material, such as a metallic wire embedded within a plastics casing. Preferably, the metallic wire is embedded within the middle of the plastics casing. By having a plastics casing, the risk of the underwire piercing a fabric sock within which it is fixed is reduced.

The underwire of the second aspect may be made of a plastics material only. By using plastics material, the risk of the underwire piercing a fabric sock within which it is fixed is reduced.

The plastics material used for either aspect of the invention may be polypropylene, thermoplastic elastomer, or an impact resistant copolymer. The impact resistant copolymer may be made by blending polypropylene with ethylene-polypylene-rubber. The hardness of the plastics can be regulated by adding calcium carbonate to the blend.

Preferably, the thermoplastic elastomer is a copolyesterether, preferably a block copolyesterether having hard and soft segments, such as co(polybutylene terephthalate)-polyether.

Preferably, the plastics casing of the underwire extends beyond the metallic wire at one end of the underwire. The plastics casing may extend beyond the underwire at both ends of the metallic wire. In one embodiment, the plastics casing extends beyond the metallic wire to a greater extent at one end of the underwire. The length of the plastics casing which extends beyond the metallic wire at the end(s) of the underwire may be approximately between 5 and 25 percent, preferably between 10 and 15 percent, of the full length of the underwire. The plastics only sections of the underwire are more flexible than the regions comprising the metallic wire and thus provide comfort to the wearer of a brassiere comprising the underwire.

In one embodiment, a web material is embedded within the plastics casing of the underwire. The web material may extend from each end of the underwire into a portion of the plastics casing within which the metallic wire is embedded. The web material provides strength to the ends of the underwire and reduces the risk of the metallic ends breaking through the plastics casing.

The length of the tapered section(s) of the underwire may be approximately between 5 and 50 percent, preferably between 15 and 25 percent, of the full length of the undenvire. Preferably, the underwire defines a plane and the end(s) of the underwire tapers in a direction perpendicular to that plane. In a preferred embodiment, the metallic wire is absent from the tapered end(s). By providing an end or ends of the underwire without a metallic wire, the ends are more flexible and there is a reduced risk of the underwire damaging a fabric sock within which it is sewn.

The ends of the underwire are preferably more flexible than the central region of the underwire. This provides the wearer of a brassiere comprising the undenvire with increased comfort because the underwire conforms more closely to the shape of the wearer.

In one embodiment, the underwire defines a plane and the thickness of the plastics casing varies in a direction perpendicular to that plane, such that the underwire is thickest at the end(s) of the metallic wire. The increased thickness at the end(s) of the metallic wire will reduce the risk of the metallic wire breaking through the plastics casing.

An underwire assembly can be provided which comprises the underwire of any of the preceding embodiments and a fabric sock for containing the underwire. The underwire may be fixed to the fabric sock, and this fixing may be achieved by bar tacking. Because the underwire has a plastics casing, there is a reduced risk of the underwire piercing through the fabric sock which enables the underwire to be fixed to the fabric sock without wire play, therefore solving the problem associated with a convention metallic underwire. A tapered end of the underwire also facilitates fixing of the underwire at its tapered end to the fabric sock by stitching means such as bar tacking.

It will be appreciated that although a “fabric sock” is referred to in this specification, the sock referred to may be made of a material other than fabric; for example it can be made of plastic material. The teen “fabric sock” is to be so construed as to include sock made of material other than fabric. A fabric sock is also called a wire channel or a wire casing.

A brassiere may be provided comprising an underwire or underwire assembly of any of the embodiments discussed above. The brassiere comprises a breast cup and the underwire assembly may be sewn to the breast cup. Alternatively, the breast cup may be molded from at least two layers, wherein the underwire assembly is molded between the two layers.

In a third aspect of the invention there is provided a method for manufacturing an underwire for a brassiere by injection molding. The underwire comprises a metallic wire embedded within a plastics casing and the method preferably comprises positioning the metallic wire within a mold; and injecting plastics material into the mold to form the plastics casing surrounding the metallic wire. The metallic wire may be held in a position in the mold such that the metallic wire is embedded within the middle of the plastic casing.

In a fourth aspect of the present invention there is provided a method of manufacturing a brassiere comprising providing an inner panel and an outer panel; placing an underwire or underwire assembly as described above between the inner and outer panels; molding together the inner and outer panels with the underwire or underwire assembly therebetween.

In a fifth aspect of the present invention there is provided a mold for manufacturing a brassiere underwire having a metallic wire embedded within a plastic casing, the mold comprising a cavity for housing the metallic wire and for injecting plastics into, such that the plastics forms a casing around the metallic wire. The mold is preferably a two part mold, each mold part comprising protrusions which extend into the cavity to locate the metallic wire at a fixed vertical and horizontal position within the cavity.

### BRIEF DESCRIPTION OF THE DRAWINGS

The present invention will now be described in detail with reference to the accompanying drawings, in which:

FIG. 1 is a front view of an underwire in accordance with the present invention;

FIG. 2 is a side view of the underwire shown in FIG. 1;

FIG. 3 is a perspective view of a second embodiment of an underwire in accordance with the present invention;

FIG. 4 is a perspective view of a third embodiment of an underwire in accordance with the present invention;

FIG. 5 is a bottom view of the underwire as shown in FIG. 4;

FIG. 6 is a perspective bottom view of the underwire as shown in FIG. 5;

FIG. 7 is a front view of an underwire assembly in accordance with the present invention;

FIG. 8 is a cross-sectional view of a method of manufacturing a brassiere including the underwire assemblies in accordance with the present invention;

FIG. 9 is a front perspective view of a two-part mold for manufacturing the underwire in accordance with the present invention;

FIG. 10A is a cross-section of a section of the two-part mold as shown in FIG. 9 in an open state;

FIG. 10B is a cross-sectional view of the closed mold with the metallic wire in place in the cavity;

FIG. 10C is a cross-section of the manufactured underwire in accordance with the present invention.

### DETAILED DESCRIPTION OF THE INVENTION

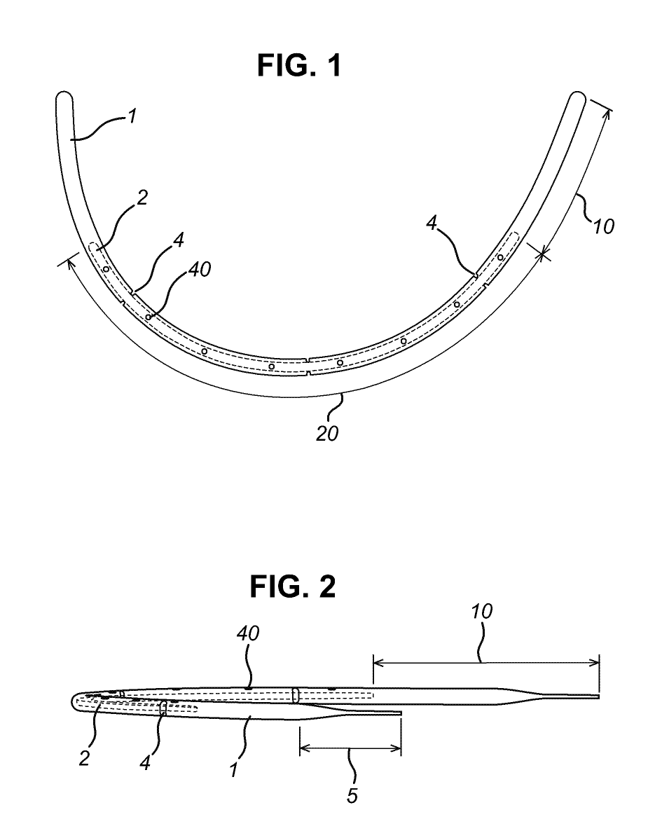

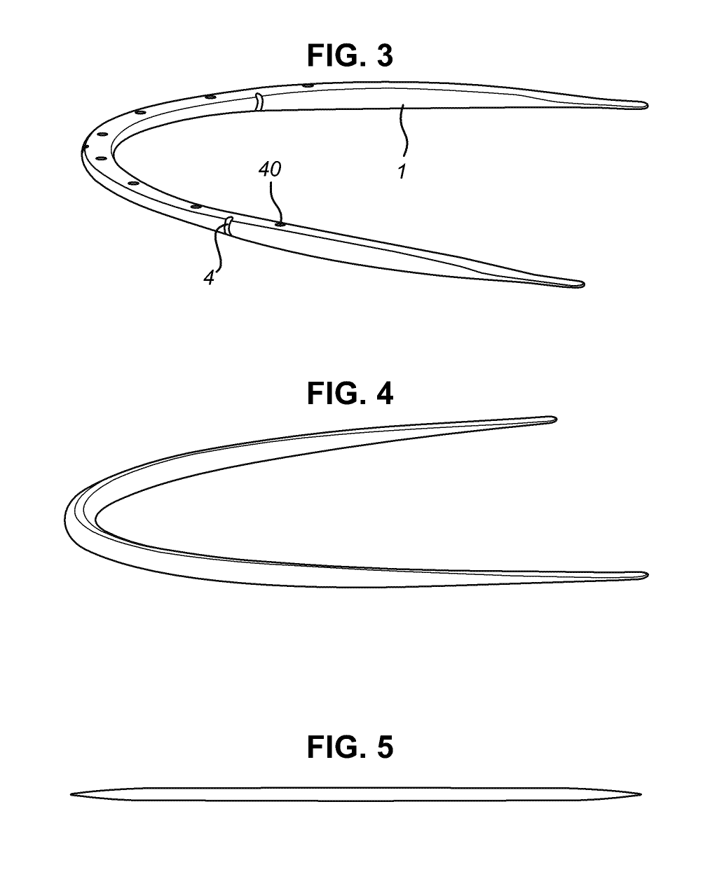

One embodiment of an underwire of the present invention is shown in FIG. 1. As shown in the figure, the underwire is substantially U-shaped, to conform to the cup of a brassiere. As can be seen by FIG. 1 and the side view in FIG. 2, the shape is not a perfect U-shape, for example one arm of the underwire has a steeper gradient and is shorter than the other arm, to conform to the breast cup.

The underwire comprises a metallic wire 2 embedded within a plastics casing 1. As shown in FIG. 1, the plastics casing 1 preferably extends beyond the metallic wire 2, such that end sections 10 of the underwire are made of plastics only. Thus, the underwire comprises a central portion 20 comprising a metallic wire 2 embedded in a plastics casing 1 and two end portions 10 which comprise the plastics casing only. Preferably, the plastics end portions 10 are solid.

By providing an underwire with a metal and plastics central section 20 and two plastics end sections 10, the underwire provides a rigid support in the central section 20 and a more flexible support at the end sections 10. Support is required most around the central region 20 of the underwire. In the end sections 10, where the metallic wire 2 is absent, the relatively softer plastics material provides comfort to the wearer of the brassiere, due to the greater flexibility of the plastics material than metal. The relatively flexible plastics sections 10 also enable the underwire to follow more closely the shape of the wearer's body when the brassiere is worn. In a conventional metallic underwire, although the metallic wire is flexible to some extent, in general, it does not follow the shape of the wearer so closely when the brassiere is worn, which is undesirable both aesthetically and in terms of comfort.

When worn, the region of the underwire that is subjected to the most flexing is the region that is most proximal the wearer's armpit. For this reason, in one embodiment, the metallic wire 2 is not centred lengthwise within the plastics casing. For example, the location of the metallic wire 2 within the plastics casing 1 could be such that the metallic wire 2 extends more toward the wearer's cleavage than toward the armpit when worn. In another embodiment, only one end of the underwire comprises a plastics only section 10. In this embodiment, the metallic wire may be included in the end of the underwire that is closest to the wearer's cleavage, but not in the end which is closest the wearer's armpit.

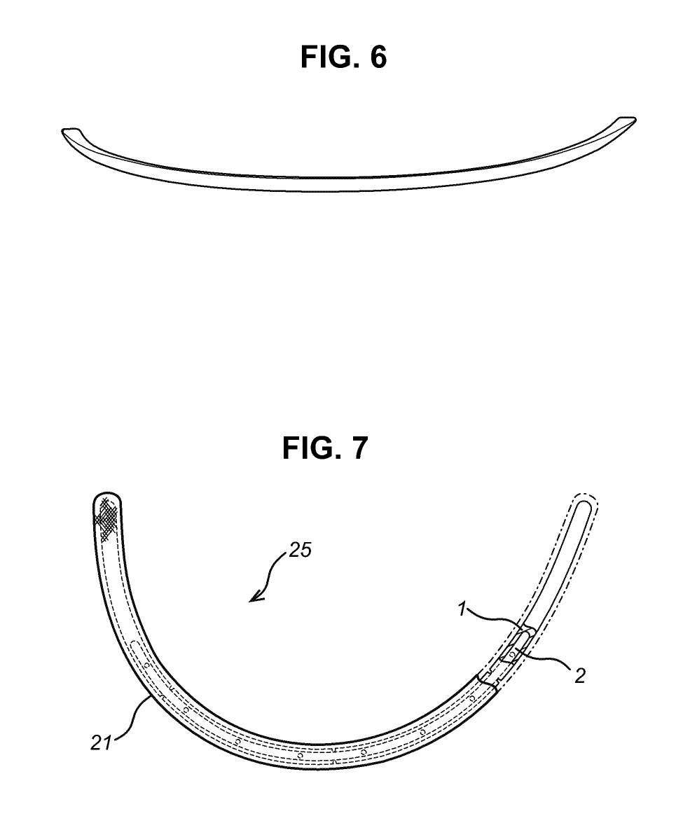

An alternative underwire of the present invention is shown in FIG. 3. As can be seen from this figure, the underwire can be formed with an increased thickness of the arms of the underwire about their midpoint, e.g. the underwire has an increased thickness between the centre point of the underwire and each of its ends. This increased thickness provides greater support at these thicker sections, relative to the tapered end sections. Furthermore, by providing thicker plastics at the point where the metallic wire 2 ends, the risk of the metallic wire 2 breaking through the plastics casing 1 is greatly reduced. Other than this modification to the shape of the underwire, the underwire is substantially identical to that described in relation to FIGS. 1 and 2.

The underwires of FIGS. 1-3 have notches 4 and holes 40 formed in the plastics casing of the underwire, which extend to the metallic wire 2, at one or more locations. The notches and holes 4, 40 are a result of the method of manufacturing the underwire, as described later.

In an alternative embodiment, the underwires as described in FIGS. 1-3, can be provided with a web material embedded within the plastics casing. In a similar way to the thickened sections of the arms in the embodiment described in relation to FIG. 3, this web material can provide strength to the ends of the arms and the sections where the metal wire 2 ends. Thus, in a preferred embodiment, the web material extends over at least a portion of the end of the metallic wire 2 and also extends to the ends of underwire which is made of the plastics casing 1 only.

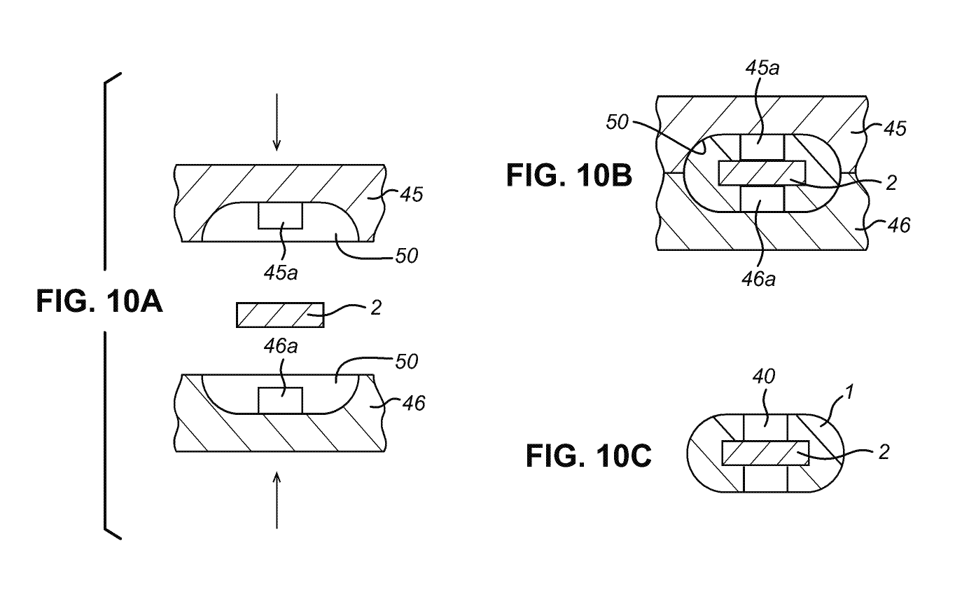

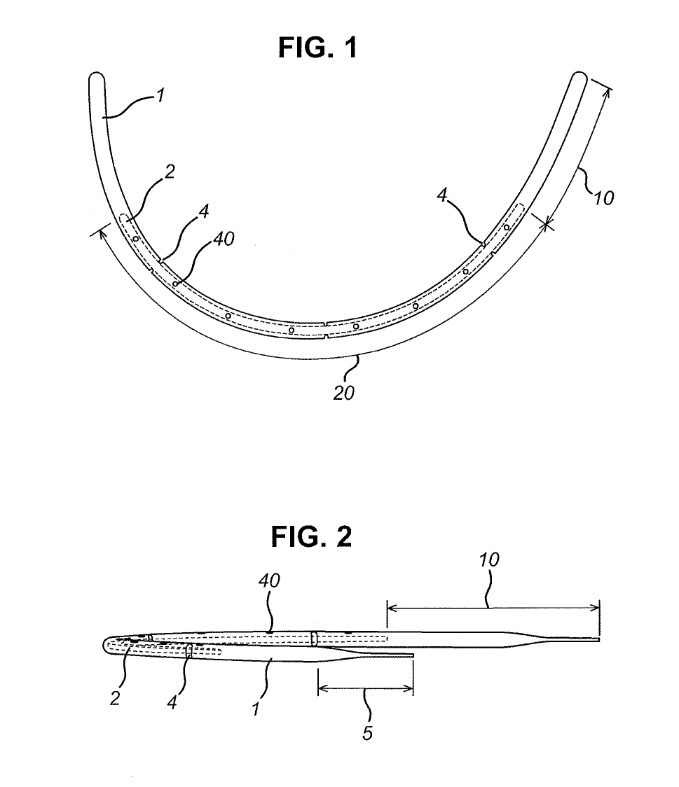

In a further embodiment of the invention, the underwire may be made of plastics material only, without the presence of a metallic wire 2, as illustrated in FIGS. 5-7. As seen in these figure, the surface of the underwire is smooth and free from the notches 4 or holes 40 as shown in the underwires of FIGS. 1-3, because the method for manufacturing the underwire is different (due to the absence of a metallic wire).

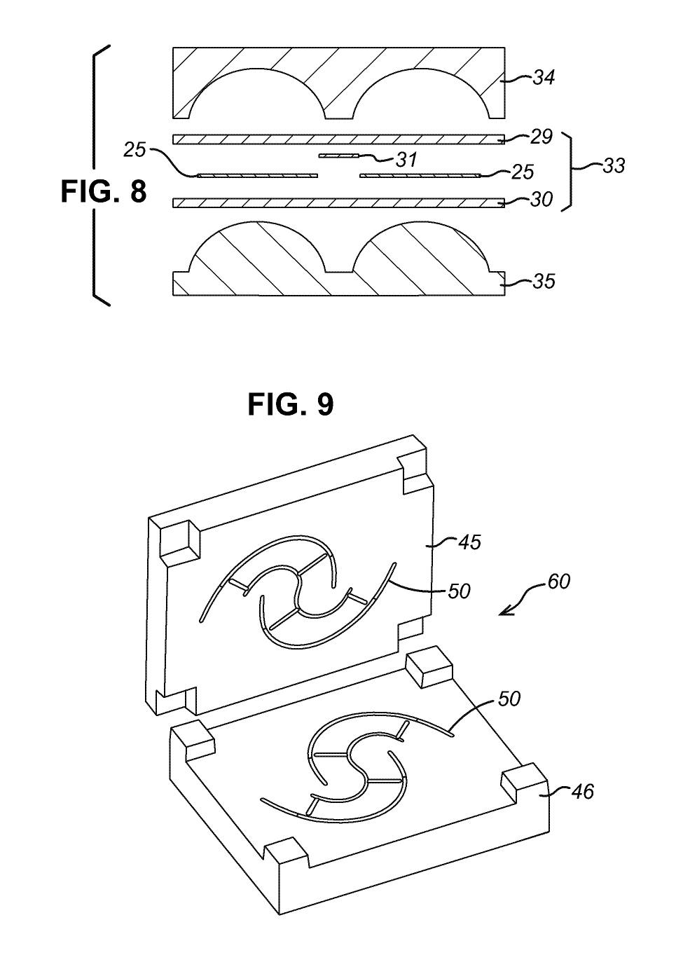

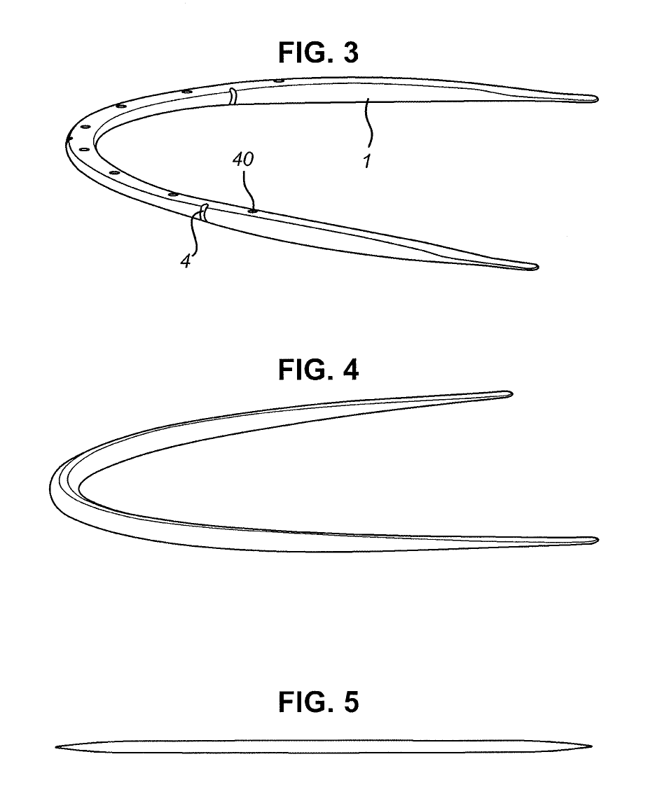

The undenvire of any of the above embodiments is preferably assembled into an underwire assembly 25, by inserting the underwire into a fabric sock 21. FIG. 7 shows the underwire assembly 25 with the sock 21 shown partially cut away to reveal the underwire of FIGS. 1-2. As shown in FIGS. 2-6, the underwire preferably tapers towards each end. Each tapered section 5 (as labelled in FIG. 2) of the underwire may extend between 5 and 50% of the full length of the underwire, e.g. the underwire could taper from a central point of the underwire towards each end of the underwire, or alternatively the end sections (perhaps 20% of the total length of the complete underwire) only may be tapered. By tapering the ends of the underwire, the underwire is able to be inserted more easily into the fabric sock. Because only one end of the underwire is required to facilitate insertion of the underwire into a fabric sock, only one end of the underwire of the embodiments as described in relation to FIGS. 1-7 may be tapered. The fixing can be accomplished for example by bar tacking. Bar tacking is a series of hand or machine made stitches used for reinforcing areas of stress on a garment and consists of a series of close-set zig-zag stitches (machine) or whip stitches (hand). Tapering also facilitates fixing of a tapered end to the fabric sock by stitching means such as bar tacking. The undenvire is attached to at least one of the ends of the fabric sock. Because the underwire includes the plastics casing, the underwire can be fixed to the sock without “wire play”. Piercing of the fabric sock is also less likely due to the plastic coating of the metallic wire.

Furthermore, the tapering of the ends of the underwire increases the flexibility of the ends of the underwire, increasing the comfort for the wearer and allowing the underwire to conform to the shape of the wearer.

Towards the two ends 10 of the underwire, support becomes less important, but comfort becomes a more important factor. Thus, by providing an underwire in which the two ends of the underwire are of greater flexibility than the central section 20 of the undenvire (through tapering or the absence of the metallic wire 2), it is possible to provide an underwire which is capable of providing the desired level of support whilst being more comfortable for the user. As stated previously, flexibility is required most in the region proximate the wearer's armpit. Thus, this end of the underwire can be made more flexible than the rest of the underwire.

The plastics material to be used for the underwire of the present invention is preferably a plastics material such as polypropylene or an impact resistant polypropylene copolymer made by blending polypropylene with ethylene-propylene-rubber. The hardness of the plastics material may be regulated by adding calcium carbonate (CaCO₃).

An alternative plastics material is a thermoplastic elastomer (rubber), preferably a co-polyesterether, preferably block co-polyesterethers having hard and soft segments, such as co(polybutylene terephthalate)-polyether, such as Hytrel® by DuPont.

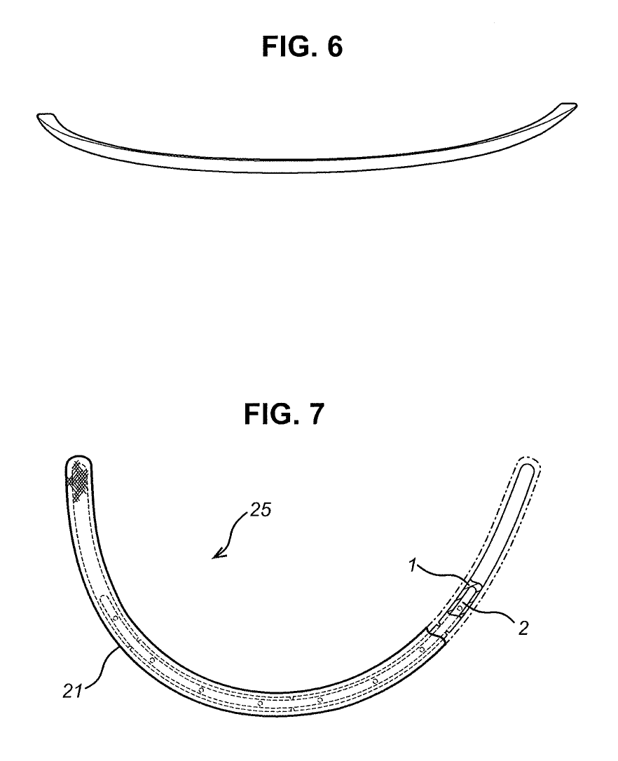

An underwire and sock 21 assembly 25 can be sewn to or into a breast cup or it can be placed between an outer panel and an inner panel and subjected to molding together with the outer and inner panels. The method of molding the underwire and sock assembly together with outer and inner panels is described in detail in U.S. Pat. No. 7,179,150, which is hereby incorporated by reference in its entirety. As shown in FIG. 8 of the present application, and as described in U.S. Pat. No. 7,179,150, two cup forms can be molded into a core assembly 33, the core assembly 33 comprising a fabric material layer 31 and two foam layers 29 and 30. Each of the foam layers 29 and 30 may be laminated to a fabric layer, the fabric layer being positioned on an exterior side of the core assembly 33. The fabric material layer 31 provides resistance against the elasticity which may otherwise be resultant in the region intermediate of the cups were there only the foam layers 29 and 30 provided at such an intermediate region. Although preferred, the fabric material layer 31 is not an essential feature of the core assembly 33. Each of the to be laminated sides of the layers 31, 29 and 30 and also the sock 21 of the underwire assembly 25 are sprayed with an adhesive whereupon they are then assembled but yet remain in a planar form. Two underwire assemblies 25 are positioned intermediate of the foam layers 29 and 30 at appropriate locations at where a cup form is to be molded into the core assembly 33 comprising of the layers 29, 30, 31 and optionally any additional layers engaged exteriorly from or intermediate thereof. Molding of the assembly of layers 33 then occurs by the mold portions 34, 35. The mold portions 34, 35 have surface relief provided thereto for the purposes of molding and introducing into the core assembly 33 two cup forms. The upper mold 34 is preferably of a temperature of 180° C. to 200° C. and the lower mold is preferably of 180° C. to 200° C. The dwell time holding the mold portions together is for example 120 seconds.

The underwire of the present invention is preferably made by injection molding. In the embodiment as described in relation to FIGS. 1-3, the metallic wire 2 is held in position within a mold and plastics material is then injected into the mold to form the underwire comprising a plastic casing 1 surrounding a metallic wire 2.

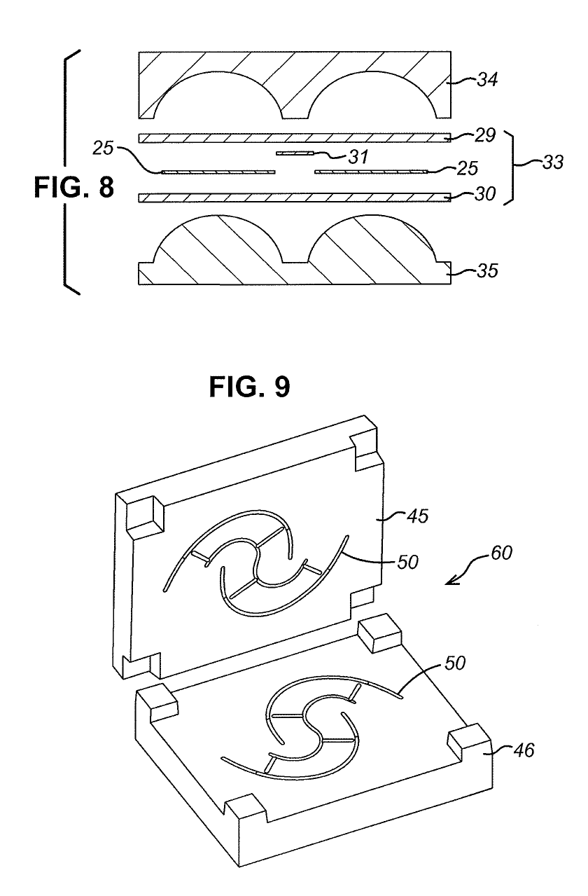

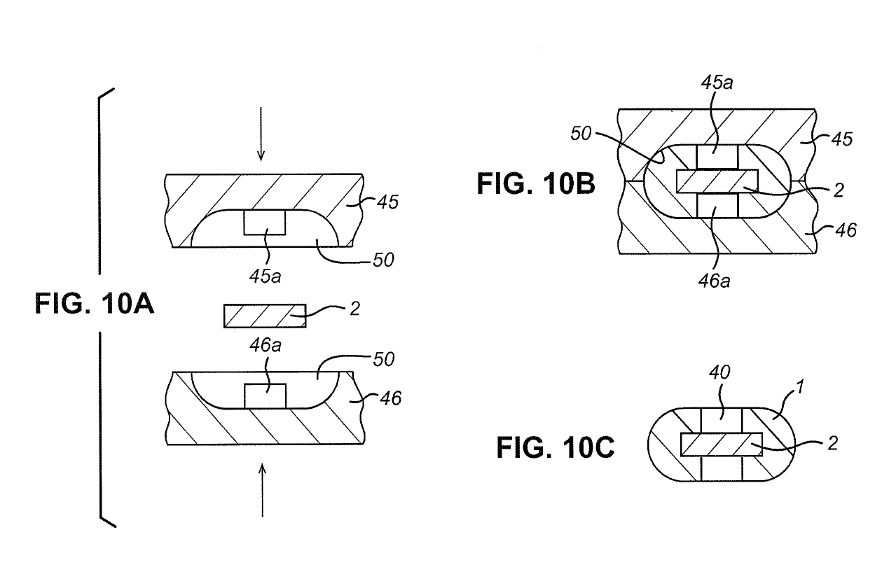

An embodiment of a mold 60 for forming the underwire of FIGS. 1-3 is shown in FIG. 9. As shown in this figure, the mold comprises two mold halves 45, 46 which, when brought together, form a cavity 50 into which plastics material is injected to form the plastics casing 1. FIG. 10A illustrates a cross-sectional view of the two mold halves 45, 46 in an open position around a metallic wire, and FIG. 10B shows the closed position of the molds with the metallic wire 2 and the plastics material 1 injected into the cavity 50. As can be seen from this cross-sectional view, the mold halves each comprise protrusions or pins 45a, 46a, the function of which is described below.

To manufacture the underwire, the metallic wire 2 of the underwire is placed between the two mold halves 45, 46 in the cavity 50 and is retained in its correct position within the cavity 50 by the protrusions 45a, 46a formed in each mold half. The protrusions 45a, 46a contact the metallic wire 2 and maintain its vertical position within the cavity 50. The mold halves 45, 46 comprise a plurality of pairs of protrusions/pins such that the horizontal and vertical position of the metallic wire 2 within the cavity 50 can be maintained to the precision required.

As a result of the mold's 60 protrusions to maintain alignment of the metallic wire 2, the plastics casing 1 of the underwire of FIGS. 1-3 comprises notches 4 and holes 40 in the plastic which extend to the metallic wire 2 of the underwire. In FIG. 1, a pair of notches 4 is located at the centre of the underwire and a further pair is located on either side of the centre, roughly equidistant between the centre of the underwire and the end of the underwire. However, the mold is not limited to any particular number or arrangement of protrusions.

By sizing the protrusions, the metallic wire 2 can be placed at any position with the plastics casing 1. Preferably, the protrusions are configured to hold the metallic wire 2 in the middle of the cavity 50, such that the underwire comprises a metallic wire 2 embedded within the middle of the plastics casing.

A method of manufacturing the underwire of the embodiments shown in FIGS. 1-3 therefore comprises proving a mold 60 comprising a central cavity 50 in the shape of the plastics casing 1 of the underwire and placing a flat metallic wire 2 on the protrusions or pins 45a, 46a within the cavity 50, as is shown in FIG. 10A. The method further comprises injecting plastics in the cavity 50 to form the plastics casing 1 around the metallic wire 2, as shown in FIG. 10B. Preferably, the method further includes maintaining the positioning of the metallic wire 2 within the cavity 50 whilst the plastics material is being injected into the cavity 50. A cross-sectional view of the underwire formed by the mold is shown in FIG. 10C.

It will be appreciated that this description is by way of example only; alterations and modifications may be made to the described embodiment without departing from the scope of the invention as defined in the claims. For example, the underwire may comprise two or more materials in general, rather than exclusively a metallic wire embedded in a plastic casing. If the inner material is of greater rigidity than a more flexible encasing material, the underwire will have similar characteristics to the specific embodiment described, in which a metallic wire is embedded in a plastics casing.

1. An underwire for a brassiere, wherein the underwire is made of two or more different materials.

2. The underwire of claim 1, wherein one end of the underwire is tapered.

3. An underwire for a brassiere, wherein one end of the underwire is tapered.

4. The underwire of claim 1, wherein both ends of the underwire are tapered.

5. The underwire of claim 1, wherein the underwire is made of a metal and a plastics material.

6. The underwire of claim 5, wherein the underwire comprises a metallic wire embedded within a plastics casing.

7. The underwire of claim 6, wherein the underwire comprises a metallic wire embedded within the middle of the plastics casing.

8. The underwire of claim 3, wherein the underwire is made of a plastics material only.

9. The underwire of claim 5, wherein the plastics material is polypropylene, thermoplastic elastomer, or an impact resistant copolymer.

10. The underwire of claim 9, wherein the impact resistant copolymer is made of blended polypropylene with ethylene-polypylene-rubber.

11. The underwire of claim 10, wherein the hardness of the plastic is regulated by added calcium carbonate in the blend.

12. The underwire of claim 9, wherein the thermoplastic elastomer is a copolyesterether.

13. The underwire of claim 12, wherein the copolyesterether is a block copolyesterether having hard and soft segments, such as co(polybutylene terephthalate)-polyether.

14. The underwire of claim 6, wherein the plastics casing extends beyond the metallic wire at one end of the underwire.

15. The underwire of claim 14, wherein the plastics casing extends beyond the metallic wire at both ends of the underwire.

16. The underwire of claim 15, wherein the plastics casing extends beyond the metallic wire to a greater extent at one end of the underwire.

17. The underwire of claim 14, wherein the length of the plastics casing which extends beyond the metallic wire at the end of the underwire is approximately between 5 and 25 percent of the full length of the underwire.

18. The underwire of claim 1, wherein the materials comprise a web material embedded within a plastics casing.

19. The underwire of claim 18, wherein the web material extends from each end of the underwire and extends into a portion of the plastics casing within which the metallic wire is embedded.

20. The underwire of claim 4, wherein a length of the tapered section of the underwire is approximately between 5 and 50 percent of the full length of the underwire.

21. The underwire of claim 20, wherein the underwire defines a plane and the end of the underwire tapers in a direction perpendicular to that plane.

22. The underwire of claim 21, wherein the metallic wire is absent from the tapered end.

23. The underwire of claim 4, wherein the ends of the underwire are more flexible than a central region of the underwire between the tapered ends.

24. The underwire of claim 15, wherein the underwire defines a plane and the thickness of the plastics casing varies in a direction perpendicular to that plane, such that the underwire is thickest at the ends of the metallic wire.

25. An underwire assembly comprising:
an underwire in accordance with claim 1; and
a fabric sock for containing the underwire.

26. The underwire assembly of claim 25, wherein the underwire is fixed to the fabric sock.

27. The underwire assembly of claim 26, wherein the fixing is accomplished by bar tacking.

28. A brassiere comprising cups, an underwire for the cups of claim 1.

29. A brassiere comprising cups and an underwire assembly of claim 25.

30. The brassiere of claim 29, wherein the brassiere comprises a breast cup and the underwire assembly is sewn to the breast cup.

31. The brassiere of claim 29, wherein the brassiere comprises a breast cup molded from at least two layers, wherein the underwire assembly is molded between the two layers.

32. A method for manufacturing an underwire for a brassiere by injection molding.

33. The method of claim 32, wherein the underwire comprises a metallic wire embedded within a plastics casing and wherein the method comprises:
positioning the metallic wire within a mold; and
injecting plastics material into the mold to form the plastics casing surrounding the metallic wire by injection molding.

34. The method of claim 33, wherein the metallic wire is held in a position in the mold and embedding the metallic wire within the middle of the plastic casing.

35. A method of manufacturing a brassiere comprising
providing an inner panel and an outer panel;
placing an underwire in accordance with claim 1 between the inner and outer panels;
molding together the inner and outer panels with the underwire therebetween.

36. A mold for manufacturing a brassiere underwire having a metallic wire embedded within a plastic casing, the mold comprising:
a cavity for housing the metallic wire and for injecting plastics into, such that the plastics forms a casing around the metallic wire.

37. The mold of claim 36, wherein the mold is a two part mold, each mold part comprising protrusions which extend into the cavity to locate the metallic wire at a fixed vertical and horizontal position within the cavity.

38-42. (canceled)
